(19) United States
(12) Patent Application Publication
(10) Pub. No.: US 2026/0016644 A1
(43) Pub. Date: Jan. 15, 2026

(54) FIBER OPTICAL CONNECTOR ASSEMBLY

(71) Applicant: Gloriole Electroptic Technology Corp., Kaohsiung City (TW)

(72) Inventors: Hsien-Hsin HSU, Kaohsiung City (TW); Yu-Cheng CHEN, Kaohsiung City (TW); Jim LIN, Kaohsiung City (TW)

(21) Appl. No.: 19/266,676

(22) Filed: Jul. 11, 2025

(30) Foreign Application Priority Data
Jul. 12, 2024 (TW) 113207506

(51) Int. Cl. G02B 6/38

(52) U.S. Cl. CPC G02B 6/3887; G02B 6/3898

(57) ABSTRACT

A fiber optical connector assembly includes a base casing, two converter seats engaged removably with the base casing, two core casings sleeved on the two converter seats, an outer sleeve sleeved on the base casing, a pressing plate connected to the outer sleeve, and a pulling unit connected to the base casing and the pressing plate. The outer sleeve is movable relative to the base casing, thereby permitting removal of the two converter seats from the base casing. Each core casing has a core casing portion sleeved on a respective one of the converter seats, and a securing portion extending from the core casing portion. The pulling unit is movable to push the pressing plate, thereby driving the pressing plate to press the securing portion of each core casing toward the core casing portion of each core casing.

### CROSS-REFERENCE TO RELATED APPLICATION

This application claims priority to Taiwanese Utility Model Patent Application No. 113207506, filed on Jul. 12, 2024, the entire disclosure of which is incorporated by reference herein.

### FIELD

The disclosure relates to a fiber optical connector assembly, and more particularly to a fiber optical connector assembly adapted to serve as an LC-type connector.

### BACKGROUND

FIG. 1 illustrates a fiber optical connector assembly 1 serving as a duplex LC-type connector that includes a base casing 11, two core casings 12, two ferrules 13, a boot 14, an optical fiber cable 15, two securing members 16, and a pressing plate 17. The two core casings 12 are transversely spaced apart from each other and are disposed on a front end of the base casing 11. The two ferrules 13 are respectively engaged with the two core casings 12. The boot 14 is connected to a rear end of the base casing 11. The optical fiber cable 15 is connected to the two ferrules 13, and extends rearwardly through the boot 14. Each of the two securing members 16 is oblique relative to a respective one of the two core casings 12, and extends rearwardly and upwardly from the respective one of the two core casings 12. The pressing plate 17 is disposed above and connected to the base casing 11, and abuts against the two securing members 16. To use the fiber optical connector assembly 1, the two ferrules 13 together with the two core casings 12 are attached to two connection ports (not shown), respectively. After the two core casings 12 are inserted respectively into the two connection ports (not shown), the two securing members 16 are resiliently and respectively engaged with the two connection ports (not shown) so as to position the two core casings 12 respectively in the two connection ports (not shown), thereby stably attaching the fiber optical connector assembly 1 to the two connection ports (not shown). To detach the fiber optical connector assembly 1, the pressing plate 17 is pressed downardly to disengage the two securing members 16 from the two connection ports (not shown). As a result, the fiber optical connector assembly 1 may be pulled rearwardly and be detached from the two connection ports (not shown).

Currently, fiber optical connectors are arranged closely to each other in a same area. The pressing plate 17 of the fiber optical connector assembly 1 spares a user the need of individually pressing the securing members 16, thereby reducing difficulty of operation. However the maximum height of the fiber optical connector assembly 1 is smaller than the maximum width of the fiber optical connector assembly 1. When a plurality of the fiber optical connector assemblies 1 are arranged closely to each other, the pressing plates 17 of the fiber optical connector assemblies 1 are adjacent to another one, thereby making it difficult for the user to press the pressing plate 17 of each of the fiber optical connector assemblies 1.

Furthermore, because the fiber optical connector assembly 1 serves as the duplex LC-type connector, the polarities of the two ferrules 13 are different from each other. For example, one of the ferrules 13 may serve as a first ferrule 13 and have a first polarity, and another one of the ferrules 13 may serve as a second ferrule 13 and have a second polarity. The two connection ports (not shown) may respectively serve as a first connection port and a second connection port arranged at different polarities. In practice, the first ferrule 13 and the second ferrule 13 are respectively inserted into the first connection port and the second connection port. However, because the securing members 16 correspond respectively in configuration with the first connection port and the second connection port, and because the orientations and placements of the first connection port and the second connection port are fixed, so the first ferrule 13 may only be inserted into the first connection port and the second ferrule 13 may only be inserted into the second connection port, thereby limiting the use of the fiber optical connector assembly 1. Under such limitation, the fiber optical connector assembly 1 is not able to be adjusted in polarity to allow the first ferrule 13 be inserted into the second connection port and the second ferrule 13 be inserted into the first connection port.

### SUMMARY

Therefore, an object of the disclosure is to provide a fiber optical connector assembly that can alleviate at least one of the drawbacks of the prior art.

According to the disclosure, the fiber optical connector assembly includes a base casing, two converter seats, two core casings, an outer sleeve, a pressing plate, and a pulling unit.

The base casing includes a casing body, four retaining block portions, and a coupling portion. The casing body has two outer lateral walls spaced apart from each other in a widthwise direction, and two installation recesses extending respectively through the outer lateral walls. Two of the retaining block portions extend respectively from the outer lateral walls of the casing body. Each of the two of the retaining block portions has an end section that is distal from the respective one of the lateral walls of the casing body and that cooperates with the respective one of the lateral walls of the casing body to form a gap therebetween such that the two of the retaining block portions are resiliently pressable toward the casing body. Another two of the retaining block portions extend respectively from the outer lateral walls of the casing body. Each of the another two of the retaining block portions has an end section that is distal from the respective one of the lateral walls of the casing body and that cooperates with the respective one of the lateral walls of the casing body to form a gap therebetween such that the another two of the retaining block portions are resiliently pressable toward the casing body. The coupling portion protrudes rearwardly from the casing body in a front-rear direction perpendicular to the widthwise direction.

The two converter seats are engaged respectively and removably with the two installation recesses.

The two core casings are sleeved respectively on the two converter seats. Each of the two core casings has a core casing portion and a securing portion. The core casing portion extends in the front-rear direction and is sleeved on the respective one of the two converter seats. The securing portion is oblique relative to a top-bottom direction perpendicular to the front-rear direction and the widthwise direction, and extends rearwardly and upwardly from the core casing portion.

The outer sleeve is sleeved on the casing body, covers the installation recesses, and is engaged removably with the four retaining block portions. The outer sleeve is permitted to move rearwardly in the front-rear direction relative to the casing body when the four retaining block portions are resiliently pressed toward the casing body to be disengaged from the outer sleeve, thereby exposing the two installation recesses and permitting removal of the two converter seats from the two installation recesses.

The pressing plate includes a joining portion, an abutment portion, and an operating portion. The joining portion is disposed above and is connected to the outer sleeve. The abutment portion is connected to the joining portion, extends forwardly, and is disposed above and abuts against the securing portion of each of the two core casings. The operating portion extends rearwardly from the abutment portion.

The pulling unit surrounds the coupling portion and is in contact with the pressing plate.

The pulling unit is rearwardly movable in the front-rear direction to push the operating portion of the pressing plate upwardly in the top-bottom direction, thereby driving the abutment portion of the pressing plate to move downwardly to press the securing portion of each of the two core casings toward the core casing portion of each of the two core casings.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating an existing fiber optical connector assembly serving as a duplex LC-type connector.

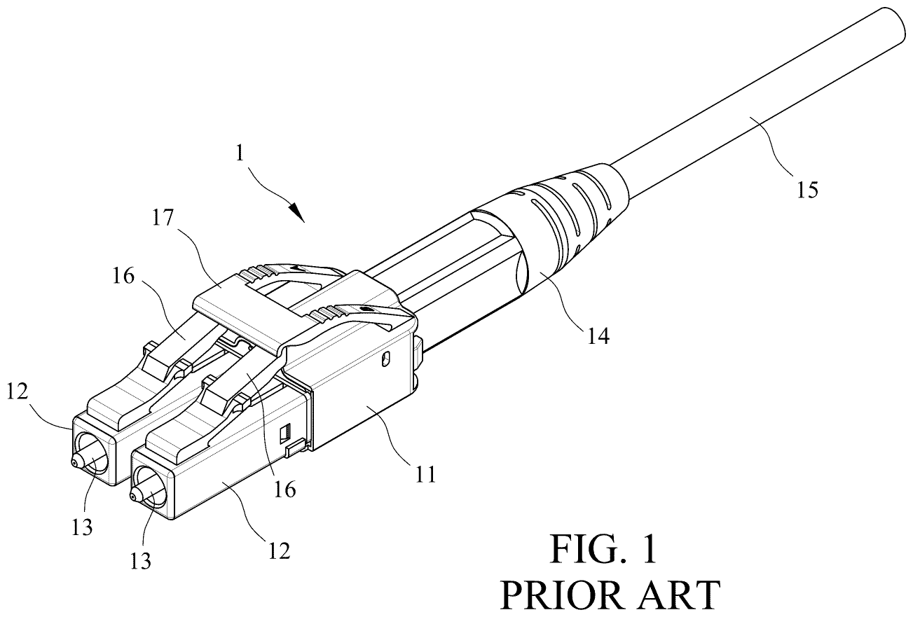

FIG. 2 is a perspective view illustrating a fiber optical connector assembly according to a first embodiment of the disclosure.

FIG. 3 is an exploded perspective view of the first embodiment illustrating the fiber optical connector assembly.

FIG. 4 is a fragmentary top sectional view of the first embodiment.

FIG. 5 is a perspective view of the first embodiment illustrating an outer sleeve of fiber optical connector assembly being moved rearwardly for a polarity change.

FIG. 6 is a fragmentary top sectional view of the first embodiment illustrating the outer sleeve being moved rearwardly for the polarity change.

FIG. 7 is a fragmentary top view of the first embodiment illustrating the fiber optical connector assembly.

FIG. 8 is a fragmentary side sectional view of the first embodiment of the fiber optical connector assembly illustrating a pressing plate pressing a securing portion toward a core casing portion of a core casing when a pulling unit is pulled rearwardly.

FIG. 9 is a perspective view illustrating a fiber optical connector assembly according to a second embodiment of the disclosure.

FIG. 10 is an exploded perspective view illustrating the fiber optical connector assembly of the second embodiment.

FIG. 11 is a fragmentary side view of the fiber optical connector assembly of the second embodiment.

FIG. 12 is a fragmentary side view of the fiber optical connector assembly of the second embodiment illustrating the pressing plate pressing the securing portion when the pulling unit is pulled rearwardly.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

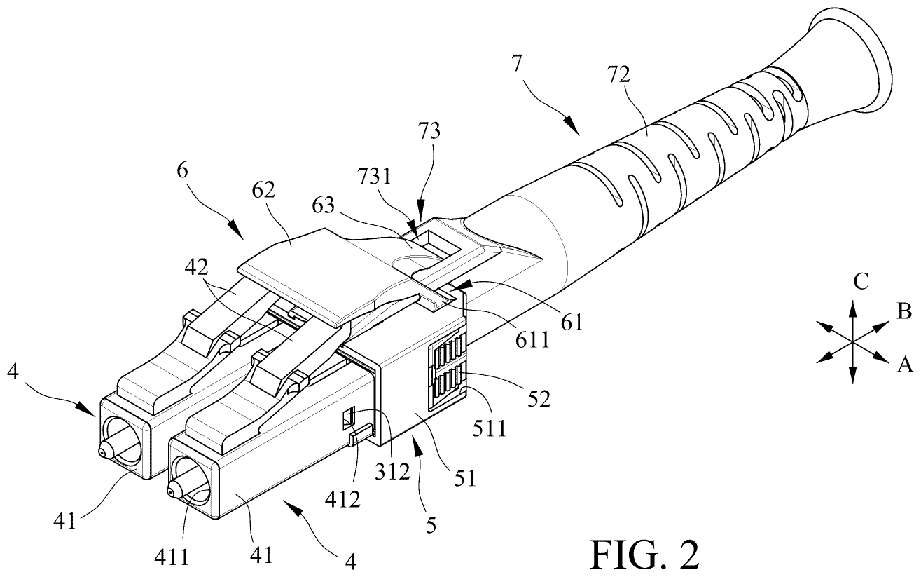

Referring to FIGS. 2, 3, and 4, a fiber optical connector assembly according to a first embodiment of the disclosure includes a base casing 2, two converter seats 3, two core casings 4, an outer sleeve 5, a pressing plate 6, and a pulling unit 7.

The base casing 2 includes a casing body 21, four retaining block portions 22, and a coupling portion 23.

The casing body 21 has two outer lateral walls spaced apart from each other in a widthwise direction (A), two installation recesses 211 extending respectively through the outer lateral walls, and two recesses 212 that are respectively in communication with the two installation recesses 211 and that extend in a front-rear direction (B) through a rear end of the casing body 21. The front-rear direction (B) is perpendicular to the widthwise direction (A). Each of the two installation recesses 211 of the casing body 21 extends in the front-rear direction (B) through a front end of the casing body 21.

Two of the retaining block portions 22 extend respectively from the outer lateral walls of the casing body 21. Each of the two of the retaining block portions 22 has an end section that is distal from the respective one of the lateral walls of the casing body 21 and that cooperates with the respective one of the lateral walls of the casing body 21 to form a gap 221 therebetween such that the two of the retaining block portions 22 are resiliently pressable toward the casing body 21. Another two of the retaining block portions 22 extend respectively from the outer lateral walls of the casing body 21. Each of the another two of the retaining block portions 22 has an end section that is distal from the respective one of the lateral walls of the casing body 21 and that cooperates with the respective one of the lateral walls of the casing body 21 to form a gap 221 therebetween such that the another two of the retaining block portions 22 are resiliently pressable toward the casing body 21.

The coupling portion 23 protrudes rearwardly from the casing body 21 in the front-rear direction (B).

The two converter seats 3 are engaged respectively and removably with the two installation recesses 211. Each of the two converter seats 3 includes an insertion portion 31, a main seat portion 32, and an engaging portion 33. The main seat portion 32 extends rearwardly from the insertion portion 31. The engaging portion 33 extends rearwardly in the front-rear direction (B) from the main seat portion 32, and is engaged removably with a respective one of the two installation recesses 211 of the casing body 21. In this embodiment, each of the two converter seats 3 has a through channel 311 that extends in the front-rear direction (B) through the insertion portion 31, the main seat portion 32, and the engaging portion 33, and that is in communication with a respective one of the two installation recesses 211 of the casing body 21. The insertion portion 31 of each of the two converter seats 3 is in a non-circular tubular form, and has two protrusions 312 that protrude outwardly and respectively from two opposite sides of the insertion portion 31 in the widthwise direction (A). For each of the main seat portion 32, a size of the main seat portion 32 in the width direction (A) is greater than a size of the insertion portion 31 in the width direction (A), and a size of the main seat portion 32 in a top-bottom direction (C) perpendicular to the front-rear direction (B) and the widthwise direction (A) is greater than a size of the insertion portion 31 in the top-bottom direction (C). In addition, the main seat portion 32 has a non-circular and hollow plate form, is engaged with the casing body 21 of the base casing 2, and is non-rotatable relative to the casing body 21 of the base casing 2. The engaging portion 33 has a circular and tubular shape so as to reduce friction against the casing body 21 during installation, thereby being easily engaged with the respective one of the two installation recesses 211 of the casing body 21.

The two core casings 4 are sleeved respectively on the two converter seats 3. Each of the two core casings 4 has a core casing portion 41 and a securing portion 42. The core casing portion 41 extends in the front-rear direction (B) and is sleeved on a respective one of the two converter seats 3. The securing portion 42 is oblique relative to the top-bottom direction (C), and extends rearwardly and upwardly from the core casing portion 41. In this embodiment, the core casing portion 41 of each of the two core casings 4 defines an accommodating channel 411 extending therethrough in the front-rear direction (B), and has two side holes 412 spaced apart from each other in the widthwise direction (A) and communicating with the accommodating channel 411. For each of the two converter seats 3, the insertion portion 31 is inserted into the accommodating channel 411 of a respective one of the two core casings 4, the two protrusions 312 of the insertion portion 31 are respectively engaged with the two side holes 412 of the respective one of the two core casings 4, and the through channel 311 is in communication with the accommodating channel 411 of the respective one of the two core casings 4. By virtue of the two protrusions 312 of each of the two converter seats 3 respectively engaged with the two side holes 412 of the respective one of the two core casings 4, the two core casings 4 are respectively and fixedly sleeved on the two converter seats 3.

The outer sleeve 5 is sleeved on the casing body 21, covers the installation recesses 211, and is engaged removably with the four retaining block portions 22. In this embodiment, the outer sleeve 5 includes a sleeve body 51 and a plurality of pressing members 52. The sleeve body 51 is sleeved on the casing body 21 to cover the installation recesses 211, and has two through openings 511 that are opposite to each other in the widthwise direction (A), and two guide grooves 512 that are spaced apart from each other in the widthwise direction (A) and that are elongated in the front-rear direction (B). The plurality of pressing members 52 extend from the sleeve body 51 into the through openings 511. The four retaining block portions 22 extend into the through openings 511 and are covered by the pressing members 52 in the widthwise direction (A). The sleeve body 51 covers the rear end of the casing body 21 in the front-rear direction (B), and the coupling portion 23 of the base casing 2 extends rearwardly through a rear end of the sleeve body 51 in the front-rear direction (B). By virtue of the aforementioned configurations, the sleeve body 51 is unable to move forwardly relative to the casing body 21 in the front-rear direction (B).

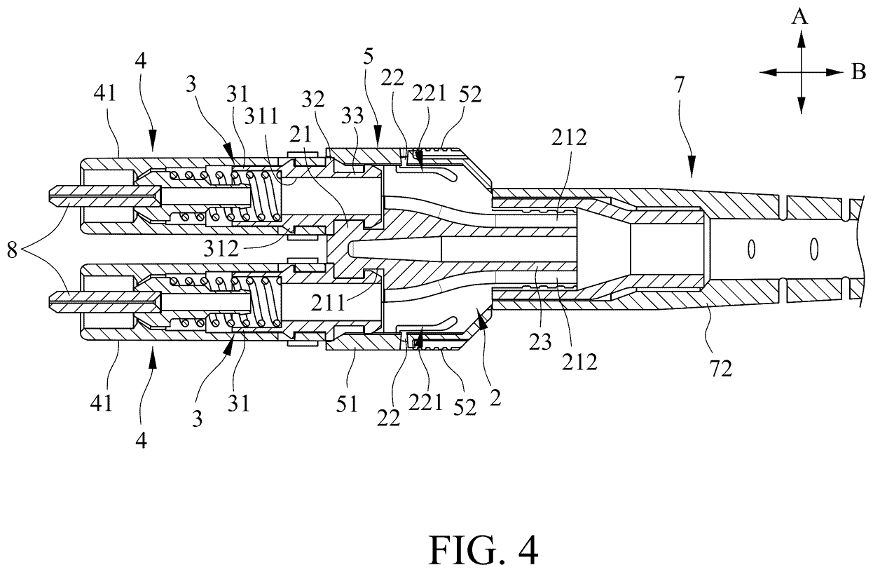

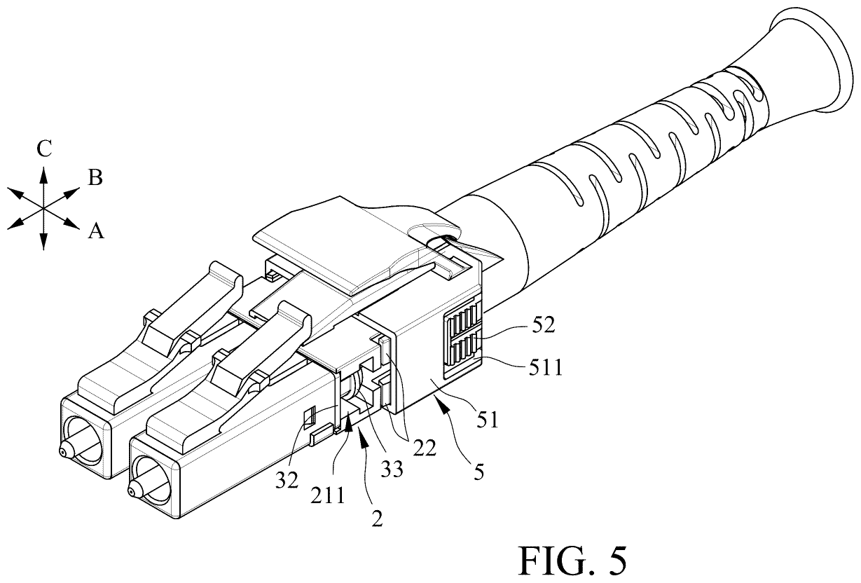

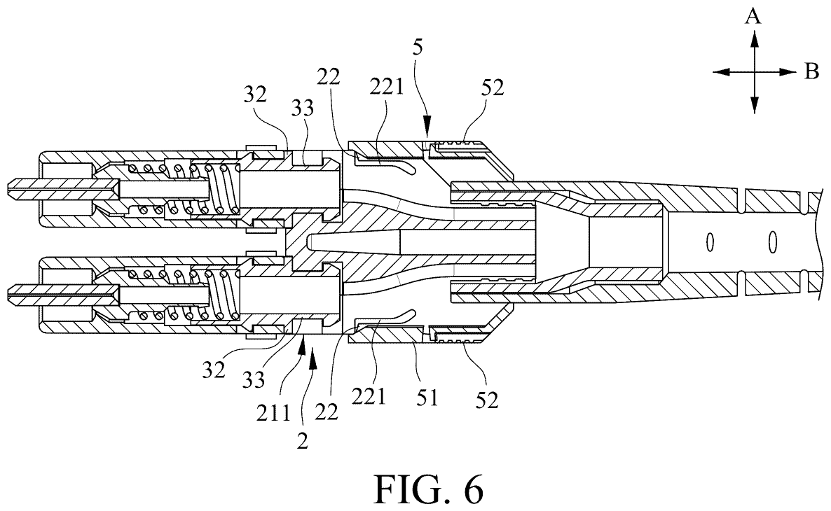

Referring to FIGS. 4, 5, and 6, because the four retaining block portions 22 extend into the through openings 511 and are engaged with the sleeve body 51, the sleeve body 51 is blocked by the four retaining block portions 22 from moving rearwardly relative to the base casing 2 in the front-rear direction (B). In this embodiment, the outer sleeve 5 is permitted to move rearwardly in the front-rear direction (B) relative to the casing body 21 when the four retaining block portions 22 are resiliently pressed toward the casing body 21 to be disengaged from the outer sleeve 5, thereby exposing the two installation recesses 211 and permitting removal of the two converter seats 3 from the two installation recesses 211. That is to say, when a user presses the plurality of pressing members 52 toward the casing body 21 in the width direction (A), the plurality of pressing members 52 are driven to press the four retaining block portions 22 toward the casing body 21 in the widthwise direction (A), thereby reducing size of the gaps 221. As a result, the four retaining block portions 22 are moved away from the through openings 511 and are disengaged from the sleeve body 51. Meanwhile, the plurality of pressing members 52 are pressed by the user and the sleeve body 51 is pulled by the user to move rearwardly relative to the base casing 2 in the front-rear direction (B) such that the two installation recesses 211 are not covered by the sleeve body 51. As shown in FIGS. 5 and 6, when the two installation recesses 211 are exposed, the engaging portion 33 is permitted to be disengaged from the respective one of the two installation recesses 211 so that the two converter seats 3 are allowed to be removed from the two installation recesses 211.

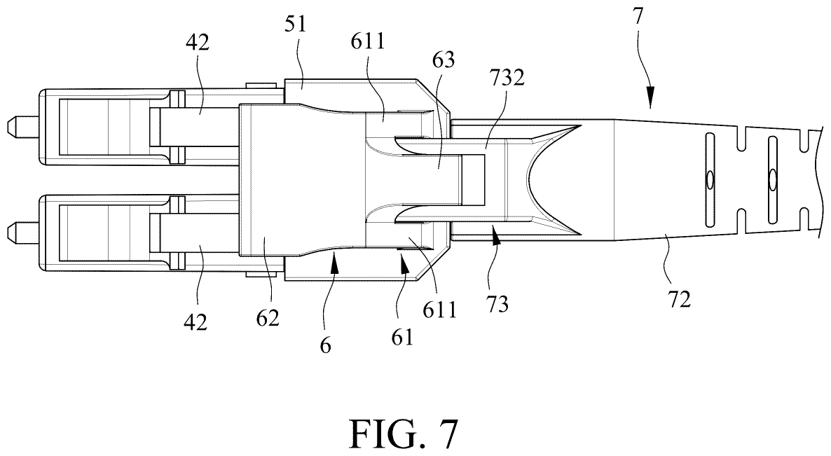

Referring to FIGS. 2, 3, and 7, the pressing plate 6 includes a joining portion 61, an abutment portion 62, and an operating portion 63. The joining portion 61 is disposed above and is connected to the sleeve body 51 of the outer sleeve 5 in the top-bottom direction (C). The abutment portion 62 is connected to the joining portion 61, extends forwardly in the front-rear direction (B), and is disposed above and abuts against the securing portion 42 of each of the two core casings 4 in the top-bottom direction (C). The operating portion 63 extends rearwardly from the abutment portion 62 in the front-rear direction (B).

The pulling unit 7 surrounds the coupling portion 23 and is in contact with the pressing plate 6. The pulling unit 7 includes an inner boot 71, an outer boot 72, and a pulling member 73. The inner boot 71 is fixedly sleeved on the coupling portion 23 of the base casing 2. The outer boot 72 is sleeved on the inner boot 71 and extends rearwardly in the front-rear direction (B). The pulling member 73 extends forwardly from the outer boot 72 in the front-rear direction (B), and has a drive window 731. The pulling member 73 is disposed between the sleeve body 51 of the outer sleeve 5 and the abutment portion 62 of the pressing plate (6) in the top-bottom direction (C). In this embodiment, the joining portion 61 of the pressing plate 6 has two joining segments 611 that are connected to the outer sleeve 5, and are respectively disposed at two opposite sides of the pulling member 73 in the widthwise direction (A). The operating portion 63 of the pressing plate 6 is oblique relative to the top-bottom direction (C) and the front-rear direction (B), and extends rearwardly and downwardly from the abutment portion 62 into the drive window 731. The pulling member 73 further has a pulling body portion 732 and two guide block portions 733. The pulling body portion 732 is disposed above the two guide grooves 512 in the top-bottom direction (C) and is adjacent to the two guide grooves 512. The two guide block portions 733 extend downwardly from the pulling body portion 732 toward the outer sleeve 5 and are slidably and respectively engaged with the two guide grooves 512. The pulling unit 7 is rearwardly movable in the front-rear direction (B) to push the operating portion 63 of the pressing plate 6 upwardly in the top-bottom direction (C), thereby driving the abutment portion 62 of the pressing plate 6 to move downwardly to press the securing portion 42 of each of the two core casings 4 toward the core casing portion 41 of each of the two core casings 4.

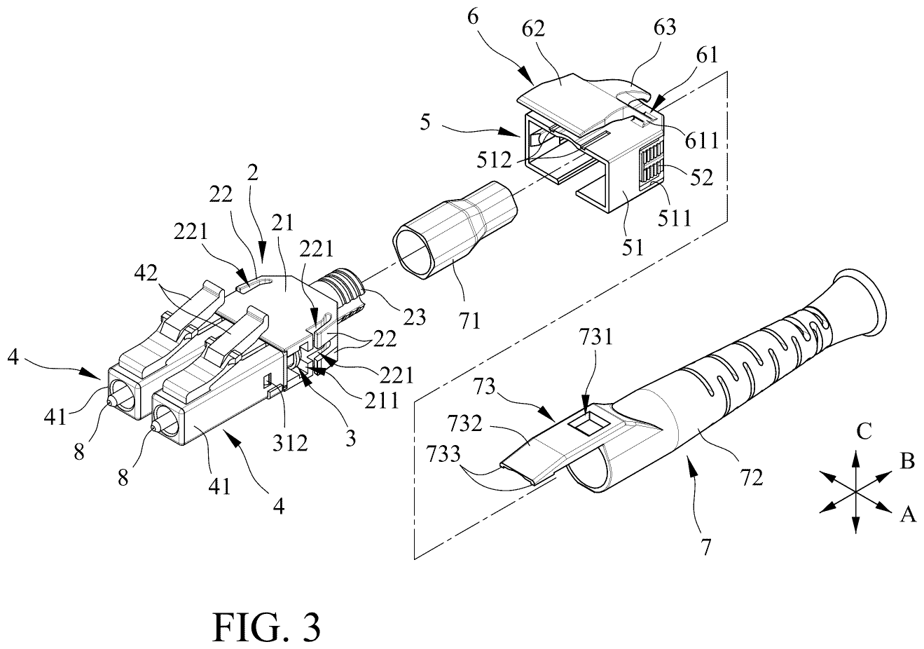

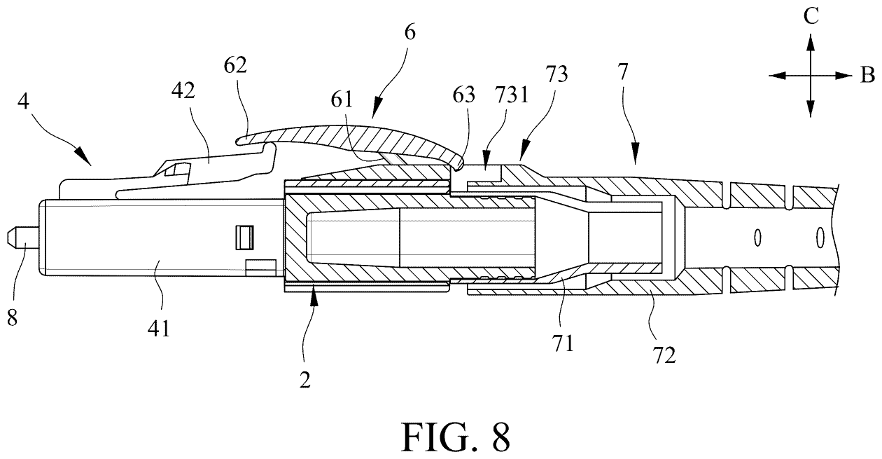

Referring to FIG. 8 in combination with FIGS. 2 and 3, when the fiber optical connector assembly of the disclosure is used, the two ferrules 8 are respectively assembled with the two converter seats 3 that are respectively sleeved by the core casing portions 41 of the two core casings 4. The two ferrules 8 together with the two core casing 4 are engaged with two connection ports (not shown) so that the fiber optical connector assembly of the disclosure is attached to the two connection ports (not shown). To detach the fiber optical connector assembly of the disclosure from the two connection ports (not shown), as shown in FIG. 8, the outer boot 72 may be pulled rearwardly in the front-rear direction (B) such that the pulling member 73 is moved together with the outer boot 72 rearwardly relative to the pressing plate 6 in the front-rear direction (B) to push the operating portion 63 of the pressing plate 6 upwardly in the top-bottom direction (C). Based on the law of the lever, the abutment portion 62 of the pressing plate 6 driven by upward movements of the operating portion 63 is moved downwardly in the top-bottom direction (C) to press the securing portion 42 of each of the two core casings 4 toward the core casing portion 41 of each of the two core casings 4 such that the securing portions 42 of the two core casings 4 may be temporarily disengaged from the connection ports (not shown) for removal of the two core casings 4 together with the ferrules 8 from the connection ports (not shown). Because the fiber optical connector assembly of the disclosure is operated along the extension direction of the optical fiber cable, operation of the fiber optical connector assembly of the disclosure is unlikely to be impeded by the fiber optical connector assemblies arranged closely to each other. When the outer boot 72 is pulled rearwardly in the front-rear direction (B), the two guide block portions 733 of the pulling member 73 are slidably and respectively engaged with the two guide grooves 512 so the outer sleeve 5 may limit movement of the pulling member 73, thereby preventing wobbling of the pulling unit 7.

After the fiber optical connector assembly of the disclosure is detached from the connection ports (not shown), as shown in FIGS. 5 and 6, the retaining block portions 22 may be pressed toward the casing body 21 to be disengaged from the outer sleeve 5 by the user pressing the plurality of pressing members 52, and the outer sleeve 5 is moved rearwardly in the front-rear direction (B) relative to the casing body 21, thereby exposing the two installation recesses 211. As a result, the two converter seats 3, the two core casings 4, and the two ferrules 8 are allowed to be removed from the two installation recesses 211. For the purpose of convenience, one of the two converter seats 3, one of the two core casings 4, and one of the two ferrules 8 are configured as a first set, and another one of the two converter seats 3, another one of the two core casings 4, and another one of the two ferrules 8 are configured as a second set. One of the two installation recesses 211 is referred to as a first installation recess 211, and another one of the two installation recesses 211 is referred to as a second installation recess 211. One of the connection ports (not shown) is referred to as a first connection port (not shown). Another one of the connection ports (not shown) is referred to as a second connection port (not shown). After the converter seat 3 of the first set is removed from the first installation recess 211 when the first set of the core casing 4 and the ferrule 8 are removed from the first connection port (not shown), and after the converter seat 3 of the second set is removed from the second installation recess 211 when the core casing 4 and the ferrule 8 are removed from the second connection port (not shown), the converter seat 3 of the first set is engaged with the second installation recess 211 so that the first set of the core casing 4 and the ferrule 8 are attached to the second connection port (not shown), and the converter seat 3 of the second set is engaged with the first installation recess 211 so that the second set of the core casing 4 and the ferrule 8 are attached to the first connection port (not shown). As a result, the fiber optical connector assembly of the disclosure may quickly switch polarities.

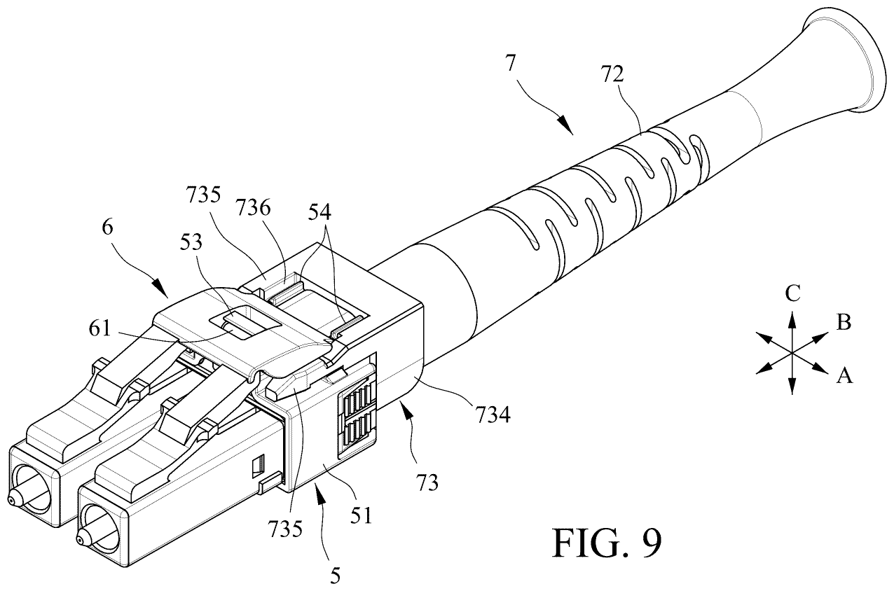

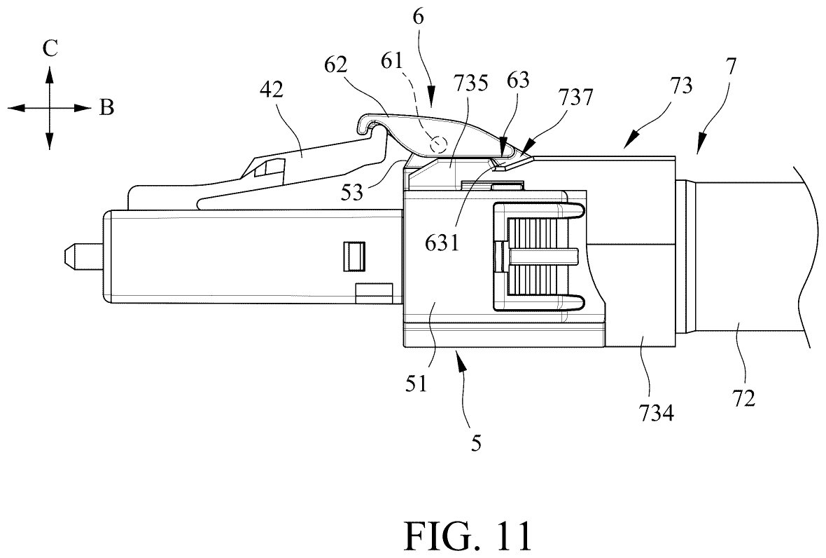

FIGS. 9, 10, and 11 illustrate a fiber optical connector assembly according to a second embodiment of the disclosure, which has a structure generally similar to that of the first embodiment. However, the outer sleeve 5, the pressing plate 6, and the pulling unit 7 of the second embodiment are different from the outer sleeve 5, the pressing plate 6, and the pulling unit 7 of the first embodiment.

In the second embodiment, the pulling member 73 of the pulling unit 7 is connected to and co-movable with the outer boot 72, and has a surrounding wall portion 734, two extension portions 735, and two notches 737. The surrounding wall portion 734 is sleeved on the outer boot 72. The two extension portions 735 extend forwardly from the surrounding wall portion 734 in the front-rear direction (B) and are disposed between the outer sleeve 5 and the pressing plate 6 in the top-bottom direction (C). The two notches 737 are respectively indented from the extension portions 735. The outer sleeve 5 further includes a pivotal seat 53 and two sliding members 54. The pivotal seat 53 protrudes from the sleeve body 51 in the top-bottom direction (C), and is disposed between the extension portions 735. The two sliding members 54 protrude from the sleeve body 51 in the top bottom direction (C), are situated rearwardly of the pivotal seat 53, and are disposed between the two extension portions 735 of the pulling member 73. Each of the two sliding members 54 has a first portion that protrudes from the sleeve body 51 in the top bottom direction (C), and a second portion that extends outwardly in the widthwise direction (A) from a distal end of the first portion such that the two sliding members 54 cooperates with the sleeve body 51 to define two sliding grooves (D) that are elongated in the front-rear direction (B). In this embodiment, the pulling member 73 of the pulling unit 7 further has two sliding blocks 736. The two sliding blocks 736 respectively extend from the extension portions 735 toward each other in the widthwise direction (A), and are respectively and slidably engaged with the two sliding recesses (D). The operating portion 63 of the pressing plate 6 has two guided segments 631 that extend rearwardly and downwardly from the abutment portion 62, and are respectively engaged with the notches 737. The joining portion 61 of the pressing plate 6 has a cylindrical shape, is elongated in the widthwise direction (A), and is connected pivotally to the pivotal seat 53, such that the pressing plate 6 is pivotable relative to the pivotal seat 53. Each of the two guided segments 631 extends obliquely relative to the front-rear direction (B) and the top-bottom direction (C), and is moveable relative to a respective one of the notches 737.

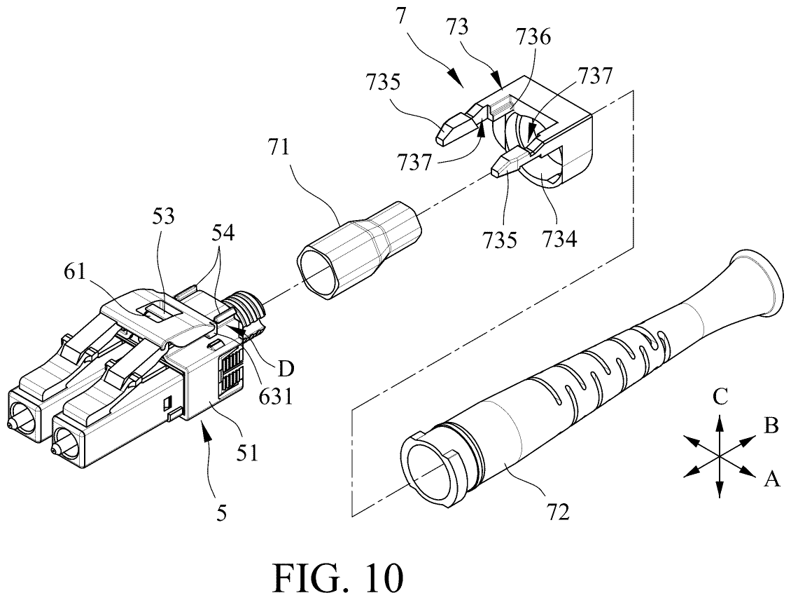

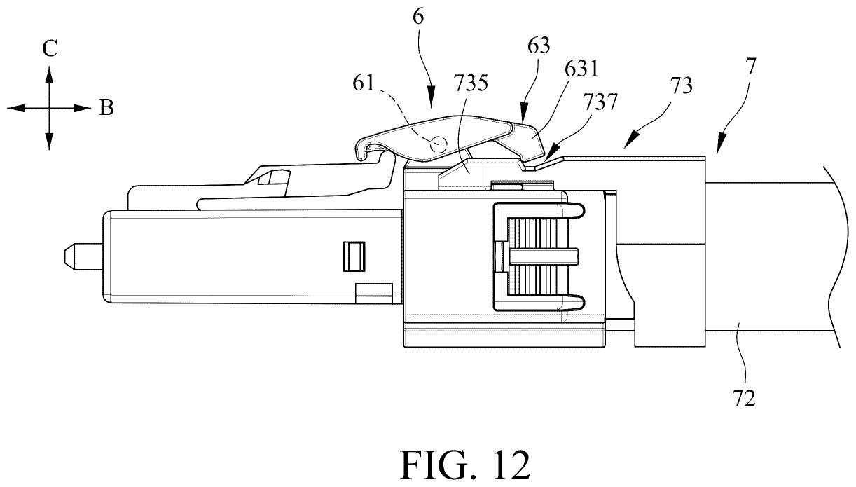

As shown in FIGS. 10, 11, and 12, when the outer boot 72 is pulled by the user to move rearwardly, the pulling member 73 is co-moved with the outer boot 72 rearwardly relative the pressing plate 6 such that the two extension portions 735 push upwardly the two guided segments 631 in the top-bottom direction (C). As a result, the pressing plate 6 may be rotated relative to the pivotal seat 53 about the joining portion 61 such that the abutment portion 62 presses the securing portion 42 of each of the two core casings 4, thereby allowing removal of the fiber optical connector assembly of the disclosure. By virtue of the two sliding blocks 736 being respectively and slidably engaged with the two sliding recesses (D), the outer sleeve 5 may provide limit movement of the pulling member 73, thereby preventing deviation of the pulling unit 7.

In summary, rearward pulling of the pulling unit 7 may drive the securing portion 42 of each of the two core casings 4 to be pressed toward the core casing portion 41, such that the fiber optical connector assembly of the disclosure is removed from the connection ports (not shown). Because the pulling unit 7 is pulled along the extension direction of the optical fiber cable that extends in the front-rear direction (B), operation of the fiber optical connector assembly of the disclosure is unlikely to be impeded by the fiber optical connector assemblies arranged closely to each other in the widthwise direction (A) and in the top-bottom direction (C), thereby being suitable in an environment where the fiber optical connector assemblies are densely arranged. Furthermore, when the outer sleeve is driven to move rearwardly relative to the casing body 21 to expose the first installation recess 211 and the second installation recess 211, the first set of the covert seat 3, the core casing 4, and the ferrule 8 is removed from the first installation recess 211, and the second set of the covert seat 3, the core casing 4, and the ferrule 8 is removed from the second installation recess 211. Subsequently, the second set of the covert seat 3, the core casing 4, and the ferrule 8 is engaged with the first installation recess 211, and the first set of the converter seat 3, the core casing 4, and the ferrule 8 is engaged with the second installation recess 211. As a result, the fiber optical connector assembly of the disclosure may quickly switch polarities.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A fiber optical connector assembly comprising:
a base casing including
a casing body that has two outer lateral walls spaced apart from each other in a widthwise direction, and two installation recesses extending respectively through said outer lateral walls,
four retaining block portions, two of said retaining block portions extending respectively from said outer lateral walls of said casing body, each of said two of said retaining block portions having an end section that is distal from the respective one of said lateral walls of said casing body and that cooperates with the respective one of said lateral walls of said casing body to form a gap therebetween such that said two of said retaining block portions are resiliently pressable toward said casing body, another two of said retaining block portions extending respectively from said outer lateral walls of said casing body, each of said another two of said retaining block portions having an end section that is distal from the respective one of said lateral walls of said casing body and that cooperates with the respective one of said lateral walls of said casing body to form a gap therebetween such that said another two of said retaining block portions are resiliently pressable toward said casing body, and
a coupling portion that protrudes rearwardly from said casing body in a front-rear direction perpendicular to the widthwise direction;
two converter seats engaged respectively and removably with said two installation recesses;
two core casings sleeved respectively on said two converter seats, each of said two core casings having
a core casing portion that extends in the front-rear direction and that is sleeved on a respective one of said two converter seats, and
a securing portion that is oblique relative to a top-bottom direction perpendicular to the front-rear direction and the widthwise direction, and that extends rearwardly and upwardly from said core casing portion;
an outer sleeve sleeved on said casing body, covering said installation recesses, and engaged removably with said four retaining block portions, said outer sleeve being permitted to move rearwardly in the front-rear direction relative to said casing body when said four retaining block portions are resiliently pressed toward said casing body to be disengaged from said outer sleeve, thereby exposing said two installation recesses and permitting removal of said two converter seats from said two installation recesses;
a pressing plate including
a joining portion that is disposed above and is connected to said outer sleeve,
an abutment portion that is connected to said joining portion, that extends forwardly, and that is disposed above and abuts against said securing portion of each of said two core casings, and
an operating portion that extends rearwardly from said abutment portion; and
a pulling unit surrounding said coupling portion and is in contact with said pressing plate;
wherein said pulling unit is rearwardly movable in the front-rear direction to push said operating portion of said pressing plate upwardly in the top-bottom direction, thereby driving said abutment portion of said pressing plate to move downwardly to press said securing portion of each of said two core casings toward said core casing portion of each of said two core casings.

2. The fiber optical connector assembly as claimed in claim 1, wherein:
said core casing portion of each of said two core casings defines an accommodating channel extending therethrough in the front-rear direction; and
each of said two converter seats includes
an insertion portion that is inserted into said accommodating channel of a respective one of said two core casings,
a main seat portion that extends rearwardly from said insertion portion and that is non-rotatable relative to said casing body of said base casing, and
an engaging portion that extends rearwardly in the front-rear direction from said main seat portion, that is engaged removably with a respective one of said two installation recesses of said casing body, and that is permitted to be disengaged from a respective one of said two installation recesses when said two installation recesses are exposed.

3. The fiber optical connector assembly as claimed in claim 2, wherein:
each of said two installation recesses of said casing body extends in the front-rear direction through a front end of said casing body;
said casing body further has two recesses that are respectively in communication with said two installation recesses and that extend in the front-rear direction through a rear end of said casing body; and
each of said two converter seats has a through channel that extends in the front-rear direction through said insertion portion, said main seat portion, and said engaging portion, and that is in communication with said accommodating channel of the respective one of said two core casings and the respective one of said two installation recesses of said casing body.

4. The fiber optical connector assembly as claimed in claim 1, wherein:
said outer sleeve includes
a sleeve body that is sleeved on said casing body and that has two through openings opposite to each other in the widthwise direction, and
a plurality of pressing members that extend from said sleeve body into said through openings; and
said four retaining block portions extend into said through openings and are covered by said pressing members in the widthwise direction.

5. The fiber optical connector assembly as claimed in claim 1, wherein:
said pulling unit includes
an inner boot that is fixedly sleeved on said coupling portion of said base casing,
an outer boot that is sleeved on said inner boot and that extends rearwardly in the front-rear direction, and
a pulling member that extends forwardly from said outer boot, that has a drive window, and that is disposed between said outer sleeve and said pressing plate in the top-bottom direction; and
said joining portion of said pressing plate has two joining segments that are connected to said outer sleeve, and that are respectively disposed at two opposite sides of said pulling member in the widthwise direction;
said operating portion of said pressing plate is oblique relative to the top-bottom direction and the front-rear direction, and extends rearwardly and downwardly from said abutment portion into said drive window.

6. The fiber optical connector assembly as claimed in claim 5, wherein:
said outer sleeve has two guide grooves that are spaced apart from each other in the widthwise direction and that are elongated in the front-rear direction; and
said pulling member further has
a pulling body portion that is disposed above said two guide grooves in the top-bottom direction and that is adjacent to said two guide grooves, and
two guide block portions that extend downwardly from said pulling body portion toward said outer sleeve and that are slidably and respectively engaged with said two guide grooves.

7. The fiber optical connector assembly as claimed in claim 1, wherein:
said pulling unit includes
an inner boot that is fixedly sleeved on said coupling portion of said base casing,
an outer boot that is sleeved on said inner boot and that extends rearwardly in the front-rear direction, and
a pulling member that is connected to said outer boot;
said pulling member has
a surrounding wall portion that is sleeved on said outer boot,
two extension portions that extend forwardly from said surrounding wall portion and that are disposed between said outer sleeve and said pressing plate in the top-bottom direction, and
two notches that are respectively indented from said extension portions;
said outer sleeve includes
a sleeve body that is sleeved on said casing body, and
a pivotal seat that protrudes from said sleeve body in the top-bottom direction, and that is disposed between said extension portions;
said operating portion of said pressing plate has two guided segments that extend rearwardly and downwardly from said abutment portion, and that are respectively engaged with said notches; and
said joining portion of said pressing plate has a cylindrical shape, is elongated in the widthwise direction, and is connected pivotally to said pivotal seat, such that said pressing plate is pivotable relative to said pivotal seat.

8. The fiber optical connector assembly as claimed in claim 7, wherein:
said outer sleeve further includes two sliding members that protrude from said sleeve body in the top bottom direction and that are disposed between said two extension portions of said pulling member;
each of said two sliding members has a first portion that protrudes from said sleeve body in the top bottom direction, and a second portion that extends outwardly in the widthwise direction from a distal end of said first portion such that said two sliding members cooperates with said sleeve body to define two sliding grooves that are elongated in the front-rear direction; and
said pulling member further has two sliding blocks that respectively extend from said extension portions toward each other, and that are respectively and slidably engaged with said two sliding recesses.
